(19) United States
(12) Patent Application Publication
(10) Pub. No.: US 2020/0160195 A1
(43) Pub. Date: May 21, 2020

(54) Method and System for Prediction of a State of an Asset

(71) Applicant: Meshnet Pty Ltd, West Perth (AU)

(72) Inventors: Justin Strharsky, Perth (AU); Hourann Bosci, Northbridge (AU); Michael Del Borrello, Gwelup (AU); Iain Geoffrey John Puddy, Cremorne Point (AU); Ian Goldsmith Meares, Dalkeith (AU); Danon Bradford, San Souci (AU)

(73) Assignee: Meshnet Pty Ltd, West Perth (AU)

(21) Appl. No.: 16/076,679

(22) PCT Filed: Feb. 9, 2017
(86) PCT No.: PCT/AU2017/050103

§ 371 Date: Aug. 8, 2018

(30) Foreign Application Priority Data
Feb. 9, 2016 (AU) 2016900429

(51) Int. Cl. G06N 5/04; G06Q 10/00; G01W 1/04

(52) U.S. Cl. CPC G06N 5/04; G01W 1/04; G06Q 10/20

(57) ABSTRACT

A method for prediction of a state of an asset comprises receiving sensor data from one or more sensors measuring a state of the asset over time; generating a comparison measurement of the sensor data over time; identifying when the comparison indicates a state of the asset has changed; creating an output when the state is indicated as having changed, as a prediction of a particular state of the asset.

### CROSS-REFERENCE TO RELATED APPLICATIONS

This application claims priority to PCT Application No. PCT/AU2017/050103, having a filing date of Feb. 9, 2017, based off of Australian application No. 2016900429 having a filing date of Feb. 9, 2016, the entire contents of both of which are hereby incorporated by reference.

### FIELD OF THE INVENTION

The present invention relates to a method and system for predicting a state of an asset.

### BACKGROUND

The state of valuable assets is often monitored in order to conduct maintenance and/or repair of the asset to keep it in good working order. Often preventative maintenance is done, which is where the asset is maintained even though it may not yet need repair, because it is more convenient or cost-effective to conduct maintenance in advance of the actual need for maintenance or repair. Additionally, preventative maintenance is also conducted in order to keep an asset in a more efficient or productive working state than if it were allowed to deteriorate to the point when repair is critically required.

Failure to maintain an asset can lead to a breakdown of the asset, decreased efficiency and/or productivity of the asset or hazardous situations. For example, where an asset is a powerline comprising power poles and electrical conductors extending between the power poles, this asset can require maintenance in order to ensure that it will hold the conductors in place so that electrical power can be transmitted through the electrical conductors. Many conditions can impact upon the asset's ability to perform this critical role. For instance, one or more power poles may deteriorate in condition which can leave the asset vulnerable to felling of a power pole or an element thereof, such as a cross arm, which in turn can lead to a break in the electrical conductor or felling of the electrical conductors, which is a hazardous situation and has been known to cause fire, or electrocution. Ensuring that the power poles maintain the correct structural condition ensures the asset can continue to perform its function. In certain weather conditions powerlines can be subjected to arcing across insulators holding the electrical conductors. This can create hazardous situations due to sparks and molten metal from the arcing as well as significant losses of electrical energy and premature ageing of the asset.

Due to the variability of environmental conditions and individual characteristics of the poles, many poles are removed from duty prior to the end of their useful life, due to: a) rules based decision making across the population of poles as a whole, for example an asset owner decides that all poles are to be removed from service at 62 years of service; b) the lack of specific information about each individual pole and how it has performed over its service life within its particular environment.

Because many powerlines are located in remote locations, effective monitoring of these assets is physically difficult, expensive and time-consuming. Traditionally a crew will physically inspect the powerline either from a motor vehicle on the ground, or by helicopter. It has also been proposed to monitor powerlines by unmanned aerial vehicles (drones). All of these options require manual visual inspection of the asset which occurs at discrete time intervals that are usually spaced apart by long periods. Often a state can occur between these long periods in which the asset may require maintenance or can be susceptible to unfavourable environmental conditions.

US Patent Application 2014/0278150 describes a utility pole assessment process largely determining alerts about extreme movement of a utility pole by measuring wind-induced movement. While wind has a significant effect on the working life of a utility pole, there are other factors that contribute to the pole's working life or efficient and/or safe use of the utility pole that US 2014/0278150 does not take into account and, as described, is not able to accommodate.

In particular, the asset may be impacted by the external environment, including trees encroaching on power lines causing lines to fall or to short; high winds combined with high temperatures and or high conductor current loads causing sag in the power lines over time, and increased lateral movement of the powerlines, allowing interaction with trees and with other assets, inducing short circuits and asset failure. Dust build-up followed by light rain can cause arcing across insulators.

Powerlines are also affected significantly by trees growing in the restricted space around the power line—called Hazard Trees in some jurisdictions, or by tree limbs or whole trees falling across power lines in storms with high winds or snow or ice loading, or a combination of these factors.

The present invention has been developed in this context.

Any references to documents that are made in this specification are not intended to be an admission that the information contained in those documents form part of the common general knowledge known to a person skilled in the field of the invention, unless explicitly stated as such.

### SUMMARY OF THE INVENTION

According to a first aspect of the invention, there is a method of prediction of a state of an asset, said method comprising:

receiving meteorological data related to an area in which the asset is located over time;
receiving sensor data from one or more sensors measuring a condition experienced by the asset over time,
generating a comparison measurement between the meteorological data and the sensor data which indicates environmental impacts on the asset over time, wherein the generation of the comparison accounts for non-environmental changes in conditions experienced by the asset over time;
identifying when there is a substantial change to the comparison measurement over time; creating an output based on the identified substantial change as a prediction of a particular state of the asset.

In an embodiment the meteorological data and the sensor data are recorded over time. In an embodiment the comparison measurement is recorded over time.

In an embodiment the asset is a powerline pole. In an embodiment the state of the asset is in need of maintenance or repair. In an embodiment the state of the asset is at risk of imminent structural failure. In an embodiment the state of the asset is that it is at risk of arcing or short circuiting. In an embodiment the state of the asset is pole top equipment maintenance or repair is likely to be needed. In an embodiment the state of the asset is a prediction of the remaining working life of the asset. In an embodiment the output is an alert about the state of the asset.

In an embodiment the meteorological data comprises wind data for the area in which the asset is located. In an embodiment the meteorological data comprises temperature data for the area in which the asset is located. In an embodiment the sensor data comprises movement data of the asset. In an embodiment the comparison measurement comprises a characteristic of a relationship between the wind and/or temperature data and the movement data. In an embodiment the received meteorological data and the sensor data are regarded as substantially different from the generated comparison measurement when measured movement of the asset is substantially different to movement predicted using the relationship characteristic between the received wind data and the movement data.

In an embodiment the sensor data comprises current loading through a conductor of the asset. In an embodiment the conductor current loading is received from a power company responsible for the asset. In an embodiment the conductor current is measured by a sensor. In an embodiment the sensor data comprises the stationary position of a pole top over time. In an embodiment the sensor data comprises the stationary angle of the pole relative to horizontal over time. In an embodiment the sensor data comprises powerline tension.

In an embodiment at least one of the sensors measures a dynamic condition experienced by the asset.

In an embodiment at least one of the sensors is used to determine a non-dynamic distortion or movement of a part of the asset over time. In an embodiment the method further comprises determining the non-dynamic distortion or movement of a part of the asset over time.

In an embodiment the generated comparison measurement accounts for one or more of the following:

non-wind related movement of the asset;

non-ambient air temperature related movement of the asset;

conductor loading on the pole;

permanent changes in the position of the pole top; and/or

changes in static loading over time.

In an embodiment the method further comprises determining a static lateral force exerted on the power pole, based on its stationary position, stationary angle, conductor current load, and air temperature. In an embodiment the method further comprises determining a dynamic lateral force exerted on the power pole.

In an embodiment the method comprises correcting the determined dynamic lateral force to account for the determined static lateral force.

In an embodiment the method further comprises correcting the determined dynamic lateral force to account for temperature effects and conductor load current effects.

In an embodiment the method further comprises tracking the displacement of the pole and the angle of the pole under a variety of current load, temperature and wind conditions, and the recording lateral displacement and lateral angle from each pole.

In an embodiment the method further comprises separating the lateral displacement and lateral angle from each pole into the components relating to current load, temperature and wind.

In an embodiment the method further comprises separating the load and temperature components of lateral pole movement during periods of low lateral wind load. In an embodiment the method further comprises analysing movement of the pole with the effects of temperature and current load having been corrected during periods of high lateral wind load.

In an embodiment the method further comprises calculating the power pole's resistance to movement, or its residual strength during each of the low wind periods and the high wind periods.

In an embodiment the method further comprises comparing the residual strength to the power pole's load case to determine whether the power pole's residual strength is sufficient to withstand the load case, using a model of the pole that has an external diameter of load bearing material, and an internal diameter of non-load bearing material.

In an embodiment the method further comprises tracking the rate of reduction of strength over time to predict the pole's future performance and when the pole's residual strength will no longer be sufficient to withstand the load case.

In an embodiment the determining the state of the asset comprises determining whether there is a sudden reduction in the permanent, changing lateral displacement and lateral angle of the pole during periods of low wind that is not attributed to a sudden increase in current load or a sudden increase in ambient temperature, or both, and in that case the state of the asset is that there is a weakness that may be attributed to the system of components that transfer the lateral force from the conductor to the pole. These may include: the state of the tie wires connecting the conductor to the insulator; the insulator that fastens the conductor to the cross arm and also acts as the insulator to prevent a short circuit to ground; the cross arm that connects the insulator to the power pole; or the cross arm connectors and the insulator connectors that carry the lateral force.

In an embodiment the determining the state of the asset comprises determining whether there is a sudden increase in the permanent, changing lateral displacement and lateral angle of the pole during periods of low wind that is not attributed to a sudden decrease in current load or a sudden decrease in ambient temperature, or both, and in that case the state of the asset is that there is a weakness that may be attributed to a the pole or a pole strengthening element at the base of the pole.

In an embodiment one of the sensors comprises a motion sensor mounted on the trees near power lines. In an embodiment the state of the asset is regarded as being susceptible to impact by a tree when the branch moves too close to the power line during periods of high winds, or due to natural growth of the tree branch.

In an embodiment one of the sensors comprises a camera mounted so as to take photos of the power line, such that the photo can be analysed with pattern recognition over time so as to identify new hazard trees or branches or faults with the cross arm, insulators and conductor tie cables and associated connectors.

In an embodiment the meteorological data comprises precipitation levels, and humidity for the area in which the asset is located. In an embodiment the sensor data comprises temperature and light levels received by a sensor at the asset. In an embodiment the comparison measurement comprises a characteristic of a relationship between the precipitation levels, humidity, temperature and the light levels received by a sensor. In an embodiment the received meteorological data and the sensor data are regarded as substantially different from the generated comparison measurement when meteorological conditions indicate high light levels, but a measurement of light sensor indicates low light level, and this may be used to indicate a build-up of dust on the asset. In an embodiment the received meteorological data and the sensor data are regarded as substantially different from the generated comparison measurement when measured light level of the asset is low and the precipitation, humidity and temperature indicate that asset has a built up of dust over a long dry period and the meteorological data suggests there is a chance of light precipitation.

In an embodiment the alert triggers maintenance of the asset or an alarm indicating that the asset is in a state that requires immediate attention.

In an embodiment the metrological data comprise one or more of: air temperature, wind speed, wind direction, quantitative precipitation, atmospheric pressure, humidity, smoke, methane, and carbon monoxide.

In an embodiment the measured data comprises one or more of: movements of the asset, settled dust on the asset, temperature of the asset, conductor tension, temperature of the pole top equipment, and current load in the conductors.

In an embodiment the meteorological data is used to determine a pole fire danger index. In an embodiment the pole fire danger index comprises a forest fire danger index, which represents the danger of a forest fire. In an embodiment the pole fire danger index comprises the Keetch-Byram Drought Index, which represents the amount of rainfall required to saturate the top 200 mm of topsoil.

In an embodiment the pole fire danger index (PFDI) is determined as follows:

PFDI=2×e^{(0.987×ln(DF)-0.45-0.0345H+0.0338T+0.0234V)}

where DF is a drought factor, T=air temperature (in ° C.), H relative humidity (as a %), V=average 10-m open wind velocity (in km/hr). In an embodiment

$$DF = \frac{0.191 \times ( K + 104 ) \times {( N + 1 )}^{1.5}}{P - 1 + 3.52 \times {( N + 1 )}^{1.5}} ,$$

where K=Keetch-Byram Drought Index, N=number of days since last rain event and P=precipitation in last rain event (in mm).

In an embodiment when the PFDI is above a threshold, light level from the sensor is below a threshold, and there is a prediction of light amounts of precipitation, an alert of an increase likelihood of arcing or short circuiting across the insulator(s) will occur is generated.

In an embodiment the movement data and angle data is used to predict current state of the asset when movement exceeds a threshold. In an embodiment the movement data is used to predict deterioration of the asset when movement is more than is expected according to meteorological data, after adjustment for the ambient temperature and the conductor current load. In an embodiment the movement threshold is determined according to a section modulus which has been modified to a notional hollow cylinder where the hollow increases in diameter with increased deterioration of the asset.

According to a second aspect of the invention, there is a method of prediction of a state of an asset, said method comprising:

receiving sensor data from one or more sensors measuring a state of the asset over time; generating a comparison measurement of the sensor data over time;
identifying when the comparison indicates a state of the asset has changed;
creating an alert when the state is indicated as having changed, as a prediction of a particular state of the asset.

In an embodiment the sensor data is movement of the asset over time during periods of no or low wind lateral to the power line direction, and during periods of high wind lateral to the power line direction, and the state is a current state of the structure of the asset.

In an embodiment a movement threshold is determined in periods of low wind lateral to the power line direction, after adjustment for the effect of temperature and conductor current load, and compared to prior records of movement in the same pole under similar conditions.

In an embodiment the sensor data is dust levels on the asset or light levels that indicate dust levels on the asset, and the state is being at risk of arcing or short circuiting across the insulator(s).

In an embodiment the sensor data is temperature, humidity, wind speed, and time since the last precipitation, and amount of the last precipitation, and the comparison measurement is an indicator of arcing or short circuit of across an insulator of a powerline.

According to a third aspect of the invention, there is a method of prediction of a state of a powerline, said method comprising:

receiving meteorological data related to an area in which the powerline is located over time;
receiving sensor data from one or more sensors measuring a condition experienced by the powerline over time;
generating a comparison measurement between the meteorological data and the sensor data which indicates environmental impacts on the asset over time, wherein the generation of the comparison is configured to identify arcing or short circuiting;
identifying when there is a substantial change to the comparison measurement over time; creating an output based on the identified substantial change as a prediction that the powerline may be at risk of arcing or short circuiting.

According to a fourth aspect of the invention, there is a system for prediction of a state of an asset, said system comprising:

a receiver of meteorological data related to an area in which the asset is located over time;
a receiver of sensor data from one or more sensors measuring a state of the asset over time;
a comparator for generating a comparison measurement between the meteorological data and the sensor data which indicates environmental impacts on the asset over time,
wherein the generation of the comparison accounts for non-environmental changes in conditions experienced by the asset over time;
a detector for identifying when there is a substantial change to the comparison measurement over time;
an output generator for creating an output based on the identified substantial change as a prediction of a particular state of the asset.

According to a fifth aspect of the invention, there is a system for prediction of a state of an asset, said system comprising:

means for receiving meteorological data related to an area in which the asset is located over time;
means for receiving sensor data from one or more sensors measuring a state of the asset over time;
means for generating a comparison measurement between the meteorological data and the sensor data which indicates environmental impacts on the asset over time, wherein the generation of the comparison accounts for non-environmental changes in conditions experienced by the asset over time;
means for identifying when there is a substantial change to the comparison measurement over time;
means for creating an output based on the identified substantial change as a prediction of a particular state of the asset.

According to a sixth aspect of the invention, there is a computer program embodied in a non-volatile computer readable medium for prediction of a state of an asset, said computer program comprising instructions for controlling a processor to:

receive meteorological data related to an area in which the asset is located over time;
receive sensor data from one or more sensors measuring a state of the asset over time; generate a comparison measurement between the meteorological data and the sensor data which indicates environmental impacts on the asset over time, wherein the generation of the comparison accounts for non-environmental changes in conditions experienced by the asset over time;
identify when there is a substantial change to the comparison measurement over time; create an output based on the identified substantial change as a prediction of a particular state of the asset.

According to a seventh aspect of the invention, there is a system for prediction of a state of an asset, said system comprising:

a receiver of sensor data from one or more sensors measuring a state of the asset over time;
a comparator for generating a comparison measurement of the sensor data over time;
a detector for identifying when the comparison indicates a state of the asset has changed;
an output generator for creating an alert when the state is indicated as having changed, as a prediction of a particular state of the asset.

According to an eighth aspect of the invention, there is a system for prediction of a state of an asset, said system comprising:

means for receiving sensor data from one or more sensors measuring a state of the asset over time;
means for generating a comparison measurement of the sensor data over time;
means for identifying when the comparison indicates a state of the asset has changed;
means for creating an alert when the state is indicated as having changed, as a prediction of a particular state of the asset.

According to a ninth aspect of the invention, there is a computer program embodied in a non-volatile computer readable medium for prediction of a state of an asset, said computer program comprising instructions for controlling a processor to: receive sensor data from one or more sensors measuring a state of the asset over time; generate a comparison measurement of the sensor data over time;

identify when the comparison indicates a state of the asset has changed;
create an alert when the state is indicated as having changed, as a prediction of a particular state of the asset.

According to a tenth aspect of the invention, there is a system for prediction of a state of a powerline, said system comprising:

a receiver of meteorological data related to an area in which the powerline is located over time;
a receiver of sensor data from one or more sensors measuring a condition experienced by the powerline over time;
a comparator for generating a comparison measurement between the meteorological data and the sensor data which indicates environmental impacts on the asset over time, wherein the generation of the comparison is configured to identify arcing or short circuiting;
a detector for identifying when there is a substantial change to the comparison measurement over time;
an output generator for creating an output based on the identified substantial change as a prediction that the powerline may be at risk of arcing or short circuiting.

According to an eleventh aspect of the invention, there is a system for prediction of a state of a powerline, said system comprising:

means for receiving meteorological data related to an area in which the powerline is located over time;
means for receiving sensor data from one or more sensors measuring a condition experienced by the powerline over time;
means for generating a comparison measurement between the meteorological data and the sensor data which indicates environmental impacts on the asset over time, wherein
the generation of the comparison is configured to identify arcing or short circuiting;
means for identifying when there is a substantial change to the comparison measurement over time;
means for creating an output based on the identified substantial change as a prediction that the powerline may be at risk of arcing or short circuiting.

According to a twelfth aspect of the invention, there is a computer program embodied in a non-volatile computer readable medium for prediction of a state of a powerline, said computer program comprising instructions for controlling a processor to:

receive meteorological data related to an area in which the powerline is located over time;
receive sensor data from one or more sensors measuring a condition experienced by the powerline over time;
generate a comparison measurement between the meteorological data and the sensor data which indicates environmental impacts on the asset over time, wherein the
generation of the comparison is configured to identify arcing or short circuiting;
identify when there is a substantial change to the comparison measurement over time;
create an output based on the identified substantial change as a prediction that the powerline may be at risk of arcing or short circuiting.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DESCRIPTION OF DRAWINGS

In order to provide a better understanding of the present invention embodiments will now be described, by way of example only, with reference to the drawings, in which:—

FIG. 1 is a schematic representation of an asset in a powerline;

FIG. 2 is a schematic representation of a power pole of the power line of FIG. 1 in communication with a system according to an embodiment of the present invention;

FIG. 3 is a block diagram of the system FIG. 2;

FIG. 4 is a screen capture of a graphical display of a set of meteorological wind data over an area of land;

FIG. 5 is a graph showing wind speed data experienced by a power pole over a year;

FIG. 6 is a graph showing pole movement;

FIG. 7 is a screen capture of a graphical display of a set of meteorological temperature data over an area of land;

FIG. 8 is a set of graphs showing humidity, temperature, wind, and precipitation free days, precipitation, drought factor and arcing or short circuiting across the insulator(s) risk over time;

FIG. 9 is a schematic block diagram of functional modules of the system of FIG. 3;

FIG. 10 is a schematic flow charge of a method according to an embodiment of the present invention;

FIG. 11 is a plot of 50 year bending moment capacity versus effective diameter of a wooden pole;

FIG. 12 is a plot of an S2 wooden pole displacement at pole top versus effective diameter for the load case force;

FIG. 13 is a schematic plan view of a hypothetically perfect straight powerline;

FIG. 14 is a schematic plan view conceptually showing a practical implementation of a straight powerline;

FIG. 15 is a schematic plan view of forces exerted on a pole top by conductors as a result of conductors not being in a true straight line;

FIG. 16 is a schematic side elevation showing conductor showing variations on conductor sag between adjacent power poles;

FIG. 17A is a schematic plan view of movement of a pole top due to forces exerted on a pole top by conductors;

FIG. 17B is a schematic side elevation showing conductor induced movement of a pole top;

FIG. 18 is a plot of a pole top movement sensor readings and temperature sensor readings; and

FIG. 19 is a plot of a pole top movement sensor readings and wind velocity sensor readings.

### DETAILED DESCRIPTION OF EMBODIMENTS OF THE INVENTION

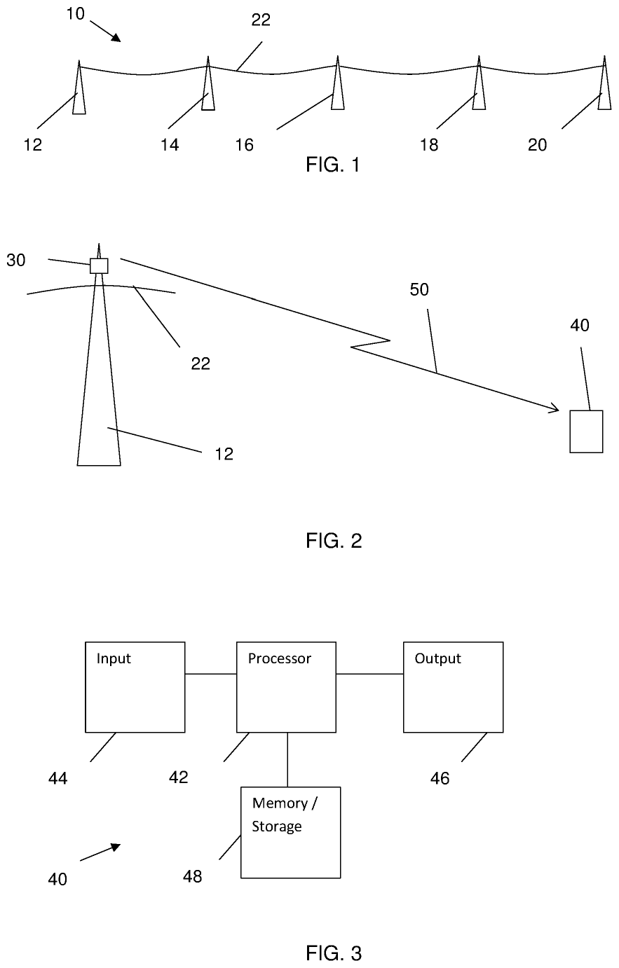

FIG. 1 shows an example asset in the form of a powerline 10, which comprises a plurality of power poles 12, 14, 16, 18 and 20 and at least one power conductor 22 extending therebetween. It will be understood that any number of power poles may form part of the asset 10. Further, whilst the overall powerline 10 is an asset, each individual power pole is also a sub asset. The present invention is intended to be applied to both the overall asset and elements (sub assets) of the overall asset.

FIG. 2 shows a (sub) asset in the form of power pole 12 which holds electrical conductor 22 above the ground. Typically there are three conductors, but there may be another number. Power poles are commonly formed of a metal pole or a wooden pole or a concrete pole. While metal power poles, concrete power poles and wooden power poles are each susceptible to different types of environmental conditions, they can each be susceptible to long-term deterioration such as from wind conditions, corrosion, cracking, rot, termite attack, acid soil attack, leading to a reduction in strength, and arcing from the conductors across the insulators due to dust build up on insulators that hold the conductors in position. These assets can also be susceptible to conditions/factors that are particular to their construction, such as, wooden poles can be susceptible to insect/animal attack/rot. The power pole 12 is fitted with a monitoring device 30 which communicates across a network 50 with monitoring system 40. The network 50 may comprise a cellular telephone network, an IP over power network, a WIFI network, satellite or other suitable technology.

Each (sub) asset (12, 14, 16, 18, 20), or some of the (sub) assets (for example 12, 16, 20) in the overall asset 10 are fitted with monitoring devices 30 which communicate across the network 50 with a monitoring system 40.

Referring to FIG. 3, the system 40 is for prediction of a state of the asset 10, or sub asset (for example power pole 12). System 40 comprises a processor 42, an input 44, an output 46 and a memory/storage 48. The memory/storage 48 is for storing data and operating instructions. The storage 48 may be in the form of non-volatile solid state memory, a hard disk drive or on-line network storage (cloud storage). The data may be stored in a database of records which provide information to the processor 42, and may be updated by the processor 42. The processor 42 may comprise one or more physical or virtual CPUs and is for executing the operating instructions so as to control the system 40 according to the operating instructions. The processor 42 is configured for accessing the information of the database of records and generating an alert as will be described below.

The input 44 comprises a network interface for communication with one or more monitoring devices 30 over the network 50, such as the Internet, a LAN, a WAN, or a VPN. The input 44 may also comprise a network connection to a source of meteorological data, such as the Australian Bureau of Meteorology, and may also include a network connection to a power company to provide a source of powerline operating data.

The output 46 comprises an alert signalling device such as a computer screen, interface to another computing device, a messaging service (for example a short messaging service) or an audio/visual indicator, such as a flashing light or siren.

The system 40 may be a personal computer or a dedicated computing system. Examples of the system 40 are the PowerEdge server line by Dell Inc or the BladeSystem server line by Hewlett-Packard Company, or an online (cloud-based) computing platform, such as provided by Amazon Inc.

Referring to FIG. 9, in an embodiment the system 40 is configured by the operating instructions to operate with the following functional modules 70:

a meteorological data acquirer 72 that acquires meteorological data, via the input 44, such as for example temperature, wind speed and direction, precipitation and humidity of an area in which the asset is located;

an asset monitoring device interface 74 that interfaces via input 44 with one or more asset monitoring devices 30 to receive data about the status of the asset. Generally this occurs periodically, such as daily, hourly, every 5 minutes or as otherwise appropriate. Some meteorological data may be acquired from the asset monitoring device 30;

a data storer 80 for storing the data in the storage 48;

a comparer 76 for comparing meteorological data to the data about the status of the asset, so as to observe characteristics of one or more relationships between meteorological conditions and the monitored behaviour of the asset, as will be described in more detail below. These characteristics may be stored by the data storer 80 in the storage 48 for later retrieval;

a data retriever 82 for retrieving the stored data from the storage 48;

a historic comparer 78 for comparing historic characteristics to recently measured data;

an anomaly detector 84 for detecting an anomaly in the observed data about the asset and/or its relationship with meteorological conditions compared to historic relationship characteristics; and an alert generator 86 for generating an alert through the output 46 when an anomaly is detected by the anomaly detector 84.

In an embodiment the operating instructions are in the form of instructions of a computer program, which is stored in a non-volatile manner in the storage 48.

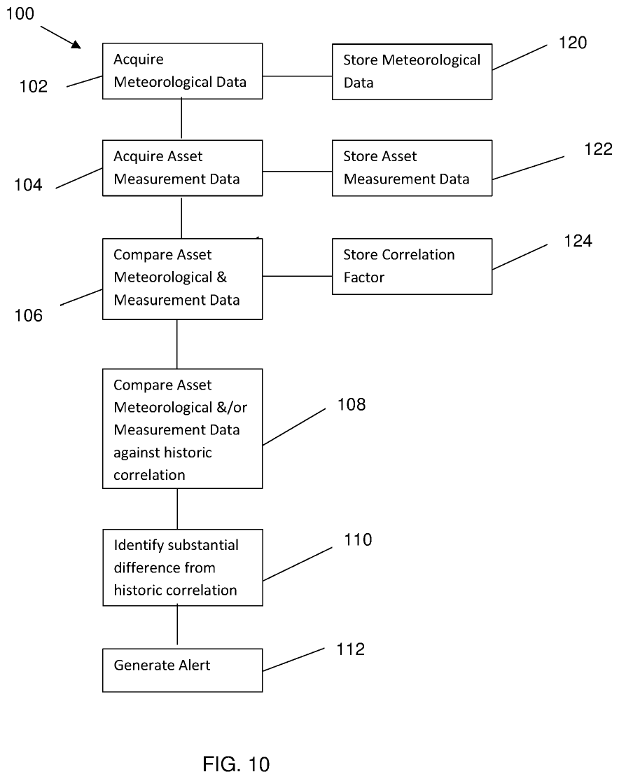

Referring to FIG. 10, there is a method 100 of prediction of a state of an asset. In an embodiment, the method comprises receiving acquired meteorological data 102 related to an area in which the asset is located over time by use of the acquirer module 72. The acquired meteorological data may be stored 120 in storage 48 by the data storer 80. Additionally sensor data from one or more sensors measuring a state of the asset is acquired at 104 by the asset monitoring device interface 74 over time. The acquired condition data may be stored 122 in storage 48 by the data storer 80.

The meteorological data and the sensor data are compared 106 and a comparison measurement is generated between the meteorological data and the sensor data which indicates environmental impacts on the asset. The comparison measurement may be stored 124 in the storage by the data storer 80. The comparison measurement reflects one or more characteristics of one or more relationships between meteorological conditions the asset is subjected to and physical effects on the asset that are measured. A relationship exists when there is a correlation between meteorological data and physical effects of the meteorological conditions. For example, when a power pole is subjected to windy conditions it will move under the influence of the wind. The movement of the power pole can be measured and the wind speed and direction can be measured, either locally at the asset or by meteorological services which make this data available. The wind speed and direction data will show a correlation with measured movement data. The normal response to the meteorological conditions the asset is subjected to is reflected in the comparison measurement. For example the normal range of movement according to the wind strength and direction is recorded. These normal responses are regarded as historic comparison measurements. In this way the normal response for each asset does not need to be preconfigured, but instead can be learnt. In a similar way, the normal movement of the asset in periods of low wind and changing ambient temperature and conductor current load can also be learnt.

As new meteorological and device data is acquired by the interface 74, this is compared 108 to the historic comparison measurement by the historic comparer 78. This allows changes of the comparison measurement over time to be analysed. When there is a substantial difference between received meteorological data, the sensor data, a comparison measurement therebetween and the historic comparison measurement, this is identified 110 as an anomaly. In this case an alert is generated 112 by the alert generator 86. As an example, if the power pole moves substantially more than it normally would in low wind conditions and high ambient temperatures and high conductor current loadings, this is regarded as an anomaly and may indicate the power pole is weakening or damaged and is in need of maintenance or replacement.

The present invention allows for more complex analysis that a simple wind speed versus wind-induced movement analysis, and for other types of analysis.

Power poles, even on straight runs, are not installed completely in line, and also change their pole angle (to vertical) over time, causing the power lines to exert a permanent, changing lateral force on the power pole that is related to the tension in the line; and that tension in the line is related to the ambient temperature and to the current load due to heat from electrical resistance. Such a lateral force causes a permanent change in the lateral displacement of the pole, and a permanent change in the lateral angle change of the pole. This can be within the design tolerance of a new pole, but (and especially when combined with strong wind) it may not be within the tolerance of a degraded pole, which may cause it to fail, or may cause increased degradation.

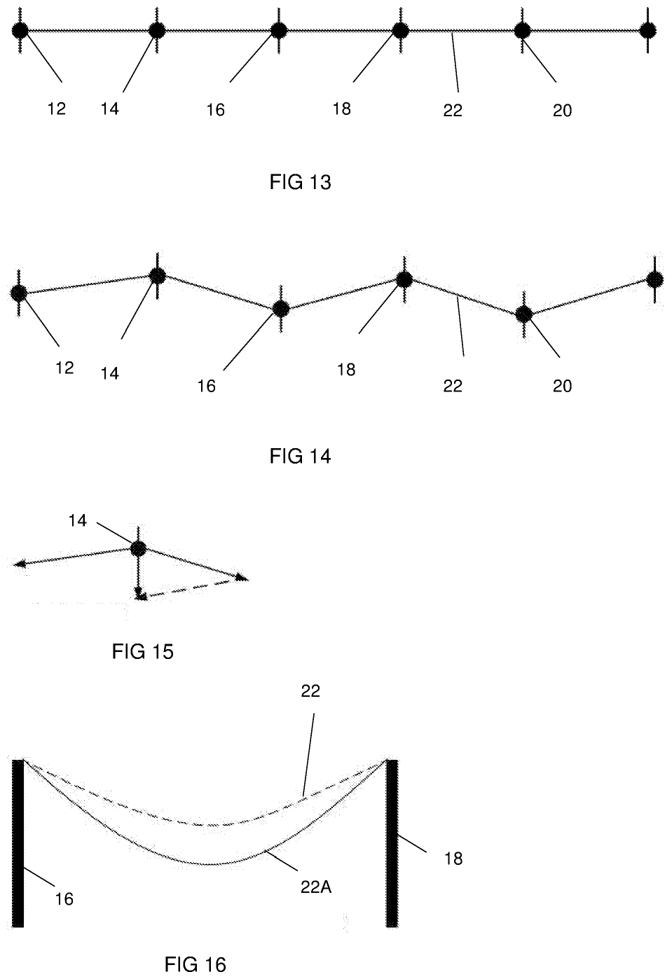

By way of example FIG. 13 shows a (hypothetical) power line installed in a straight line at the pole bases and with perfect alignment. FIG. 14 shows the same line installed in practice, with imperfect alignment, and with a lack of true vertical installation and also pole movement over time. FIG. 15 shows the resultant force (being the vector sum of the conductor tension forces) on the pole from the now misaligned conductor tensions, acting to bring the pole back to the correct alignment. FIG. 16 shows how the tension on the pole, and hence the resultant force, changes dependent on the sag of the power line. The change in sag on the power line is dependent upon the elongation of the conductor caused by changes in the internal temperature of the conductor due to its positive coefficient of linear thermal expansion. In this Figure, 22 represents the power line conductor when it is cold, with relatively less sag. Also 22A represents the power line conductor when it is hot, with relatively more sag. The internal temperature of the conductor is dependent upon: a) the ambient temperature; b) the conductor current load (due to positive electrical resistance of the cable); c) the loss of heat from the conductor due to wind. Other environmental forces that impact sag and tension include ice load and snow load.

The power lines are influenced by lateral wind force on the conductor over the conductor span, causing a temporary, changing lateral force to be exerted on the power pole that is related to the square of the lateral wind velocity. Such temporary changing lateral force causes a temporary, changing lateral displacement of the pole, and a temporary, changing lateral angle change of the pole.

When the pole angle and displacement are sampled with a high enough frequency, for example every 5 minutes, together with the conductor current load, the ambient temperature and the lateral wind velocity, for periods of low lateral wind, the impact of the misaligned conductors, and the changing resultant tension can be seen in the movement of the pole on a diurnal basis, as the temperature and the load fluctuates, refer to FIG. 18 which shows movement sensor readings that have been converted into lateral pole angle readings (from horizontal), and temperature sensor readings of a pole top.

The periods of low lateral wind are used to analyse and separate the load and temperature components of lateral pole movement. Periods of high lateral wind are then also analysed with the effects of temperature and current load having been corrected.

Each of the low wind periods and the high wind periods are used to calculate the power pole's resistance to movement, or its residual strength.

The residual strength is then compared to the power pole's load case to determine if the power pole's residual strength is sufficient to withstand the load case, using a model of the pole that has an external diameter of load bearing material, and an internal diameter of non-load bearing material, as discussed further below.

This situation is similar in pole configurations where there is a change of direction at a pole and it is not stayed, or in situations where the stay is not perfectly designed or installed.

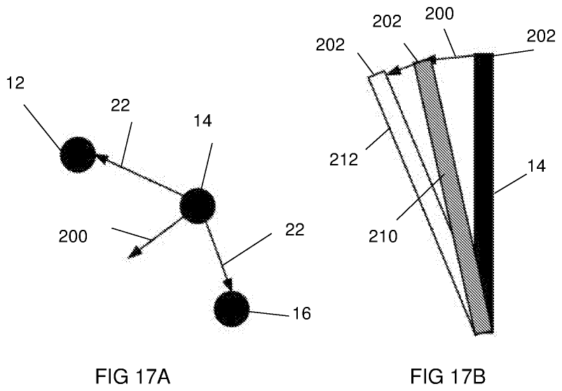

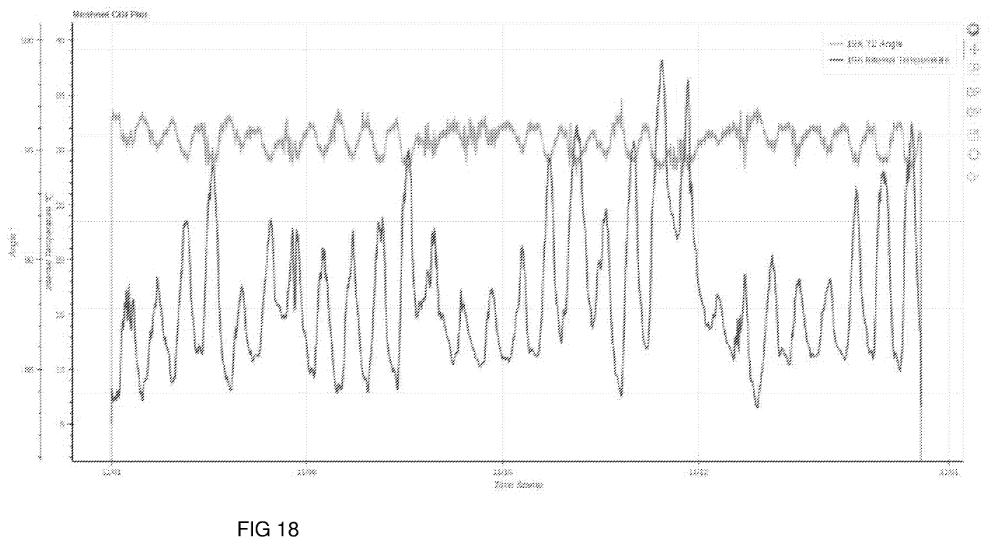

FIG. 18 shows data for the month of November 2016 taken from a pole sensor with samples taken every 5 minutes, showing the lateral pole angle and the sensor reading of internal temperature of the conductor. There is a good correlation between the sensor internal temperature increasing (increasing sag and reducing conductor tension) and reducing pole angle, indicating a movement back towards vertical. The pole these measurements were taken on was an unstayed pole, with a slight change in direction at the pole, and the pole is not vertical. This is shown in FIGS. 17A and 17B, in a simplified diagram. In FIG. 17A due to the tension from the conductors 22 on each either side of pole 14 the pole top is induced to move in the direction indicated by arrow 200. FIG. 17B schematically represents the increased movement of the pole top 202 from the vertical position represented by 14, to a bent position 210 and then to a more bent position 212. Whilst the bending is shown to occur at the base, in reality there will be bending occurring along the length of the pole.

The load case for the pole is the description of the design loads the pole has been designed for, and is supplied by the power utility company, together with the pole's age, and physical characteristics, including the type of conductor, and the span between the poles.

Given the conductor internal temperature can be measured, and the angle of the conductor sag can also be measured, and the sag can also be calculated using a calculated conductor internal temperature, the resultant tension can be calculated, and the residual strength of the pole can be calculated from the measured lateral movement of the pole.

During low lateral wind periods, the pole position can be adjusted for the effect of ambient temperature and the effect of the conductor current to remove these effects. This Adjusted Pole Position can be trended over time, to establish whether there are material changes. In situations where there are material changes, this can then be cause to investigate the pole top equipment (conductor ties, insulators, insulator connectors; cross arm, cross arm connectors) to establish whether the load transfer from the conductor to the pole is intact. Where the pole position shows less than expected movement, this indicates that the conductor lateral load is not being transferred completely to the pole. Where the pole position shows more than expected movement, this indicates that the pole itself has lower residual strength than previously, and the pole itself, or the pole strengthening equipment has weakened.

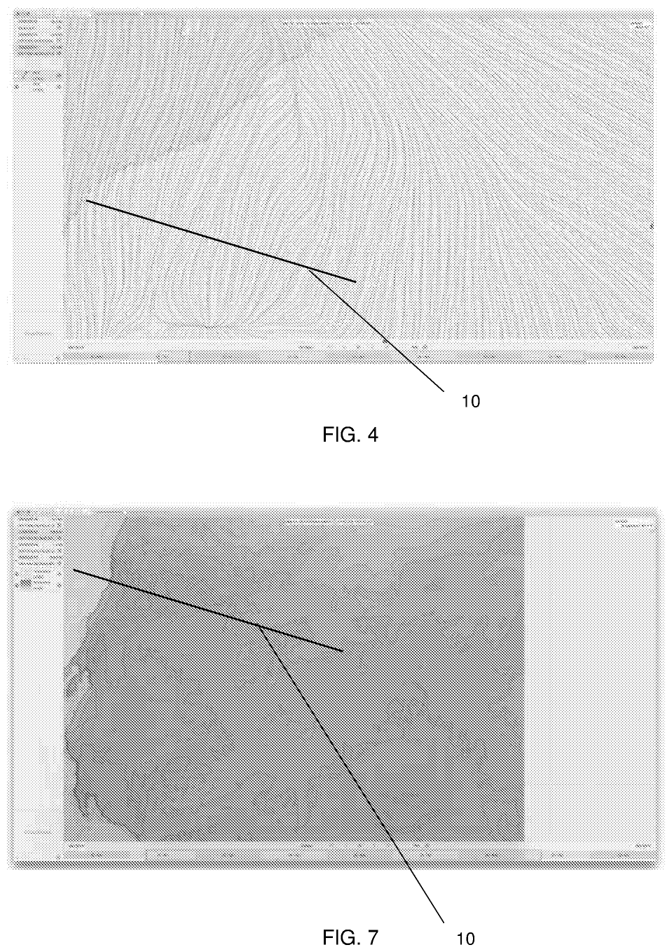

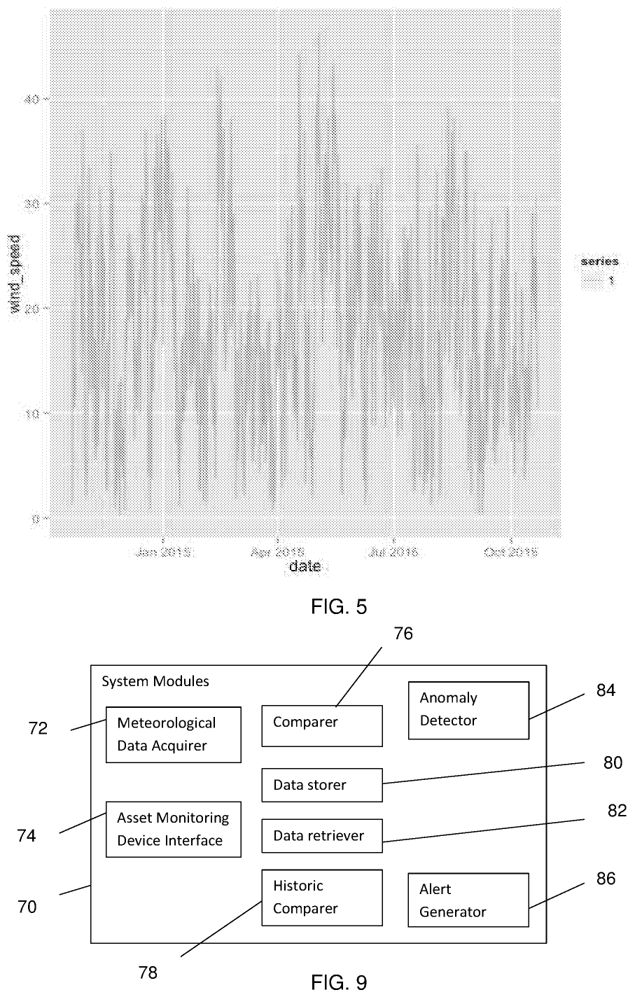

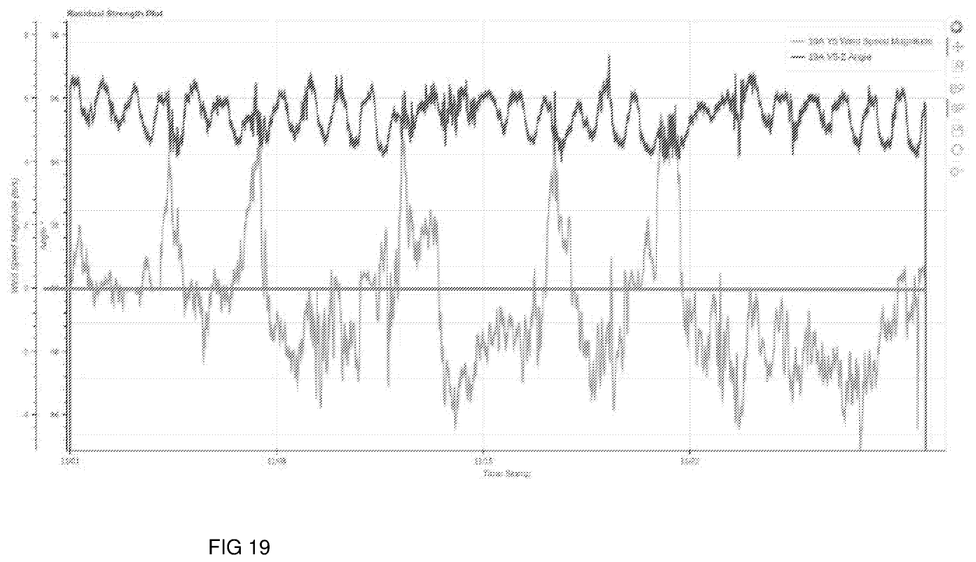

By way of example FIGS. 4, 18 and 6 illustrate the wind conditions example in more detail. In FIG. 4 a power line 10 is depicted as being subjected to various wind conditions. This wind data can be obtained from a meteorological service. Alternatively, wind measurements can be taken by measurement devices 30 on some or all of the power poles 12, 14, 18, 20 of the power line 10. Poles may be clustered by proximity and compared to meteorological service data, depending on the scale of the area that the data represents. The lateral movement of each pole according to the measured data is compared to the lateral component of the wind data. Where the line changes position at the pole, it is necessary to calculate the correct resultant angle of the wind acting on each of the two conductor spans connecting to the pole. Prior to comparing the lateral movement of the pole with the lateral wind velocity component, it is necessary to adjust for the diurnal movement of the pole due to changing conductor tensions. In order to do this the measured pole position needs to be adjusted for resultant line tension, arising from the changing conductor sag, caused by changes in ambient temperature and conductor current load. The measurements and the wind data need to be available at similar intervals, and several measurements should be taken each hour, in order to obtain sufficient data points showing significant wind events. In FIG. 19, samples of lateral wind velocity and lateral pole angle have been taken each 5 minutes. The pole position has not been adjusted for the temperature and conductor current. The diurnal movement of the pole can be clearly seen. There is little correlation visible between the measured (and unadjusted) lateral pole position and the lateral wind velocity, however there are some periods where winds of 4 m/s appear to have changed the diurnal pattern to an extent. A longer sample period is required, ideally with much higher winds, to determine this.

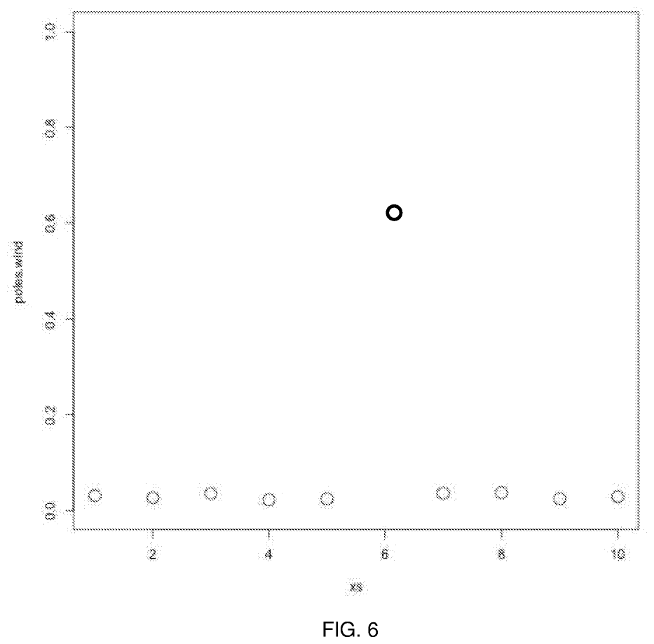

FIG. 6 shows a graph of the relationship between measured movement (corrected for the diurnal effect) and wind conditions of a number of power poles (x-axis). Poles 1 to 5 and 7 to 10 have small deviations from a historical average of 0.04. However pole 6 shows a significant deviation, with a value of about 0.6. This would raise an alert that this power pole is in need of inspection or maintenance. Resources need not be expended on the remaining poles at this time as their movement response to wind conditions is as expected. Using this method, the asset owner is able to determine those poles in the power line that have sufficient strength to have service lives considerably longer than the average service life, creating a way to fully utilise the available service life of all of the poles in the asset owner's power line network.

In another example the movement of the pole can also be compared to a theoretical threshold for normal movement. The theoretical threshold can be calculated as follows.

The diameter of the pole will fall within a range suitable for the type of pole used for that asset. A moment of inertia analysis can be conducted to determine the amount of movement that is acceptable for that type of pole. In an embodiment the pole is regarded as a cantilever beam secured at one end to a base (which is the ground) and which is deflected over its length. To determine the maximum allowable deflection at its free end, a force P, representing the sum of the lateral forces exerted on the pole by the conductors at the cross arm height l above ground creates a maximum allowable bending moment M at the base of the pole is M=P×l.

For wooden poles, each pole, even within a specific species and height and diameter, contains differences in physical characteristics that result in different residual strength, at the start of its life. Due to the differing environmental conditions that the pole experiences, including soil type, moisture content of soil, soil restraining forces, degree of compaction around the hole, diameter and depth of the hole, rainfall, humidity, temperature, wind exposure, load, verticality of the pole, load of the conductors, tension of the conductors, each pole will progress through its useful life with a different rate of reduction of strength over time, leading to a different useful life. Some poles have hidden defects that result in very short life spans before failure. These poles are a problem for the industry as they generally are not found until they have failed and caused a power outage.

Where the material of the pole is wood, M will decrease as the service life of the pole increases, due to a range of possible reasons, including the degradation of the wood, a reduction in the load carrying capacity of the wood cross section, a hidden defect in the wood in a part of the pole, and the hole environment of the pole, including soil restraining capacity, moisture content, presence of fungi, etc. This decrease in M can be modelled as a reduction in the amount of the cross sectional area of the pole that can carry load, with such an approach reflecting that a decrease in the moment of inertia (from degradation of the pole) will cause larger deflection in the pole. In this example the length l of the pole is taken to be 10 m in length and the external diameter of the pole is taken to be 250 mm, but other lengths and diameters are also common.

The maximum deflection z lateral to the power line direction of the pole cross arm can be calculated as follows:

$$z = \frac{{Pl}^{3}}{3 {EI}^{′}}$$

where P is the maximum allowable force lateral to the power line direction, exerted by the cross arm on the pole, at the cross arm height from the ground (determined as per above), l is the length of the pole (ground to cross arm), E is the Youngs Short Duration Modulus of Elasticity of the wood of the pole, and I is the second moment of Inertia.

The deflection y at a particular height x (from the ground) can be calculated as follows:

$$y = \frac{{Px}^{2}}{6 E I} ( 3 l - x )$$

Where the wood degrades with age it may be regarded as a hollow cylinder with an outer radius r₂ defined by the circumference of the pole in cross section and an inner radius r₁ defined by the inside radius of the notional hollow of the cylinder. The second moment of Inertia, I is defined as:

$$I = \frac{π}{4} ( {r}_{2}^{4} - {r}_{1}^{4} )$$

In the current example, r₂ will be 125 mm. In this case I=1.49×10⁻⁵ m⁴. For a new pole r₁=0. A pole with approximately half the load carrying capacity will have a degraded hollow core such that r₁=0.84×r₂, or in this example, r₁=0.105 m, and the effective diameter (the remaining cylindrical thickness) is 40 mm. In this case, I=9.63×10⁻⁵ m⁴.

E is a value selected according to the type of wood. For woods in strength group 2, including eucalypt, E=18500 MPa.

According to a suitable standard, such as AS4676, the bending moment capacity at the base of the pole (φM) is as follows:

φM=φ.k₁.k₂₀.k₂₁.k₂₂.k_{d}. [f.Z], where:
a. φ is a capacity factor for the characteristic strength of poles graded to a suitable standard, such as AS2209, which is 0.9.
b. k₁ is a load duration factor, which for permanent wind and imposed action is 1.
c. k₂₀ is an immaturity factor, which for eucalypt or corymbia poles of mid-length diameter>=125 mm is 1
d. k₂₁ is a shaving factor to account for a pole that is shaved to a smooth cylindrical form during manufacture, which for eucalypt or corymbia poles is 0.85.
e. k₂₂ is a processing factor to account for a reduction in strength due to steaming during manufacture, which is 0.85.
f. k_{d} is a degradation factor to account for a loss of strength due to degradation below ground over time, for a 20 year life of a treated hardwood 1.0 is used, or for a 50 year life 0.85 is used for a pole diameter between 250 and 400 mm
g. f is the characteristic bending strength of the wood of the pole, for eucalypt poles of S2 strength classification f is 80 MPa.
h. Z is the section Modulus of round timber calculated as follows

$$Z = \frac{{d}_{p}^{3}}{32} ,$$

where dₚ is pole diameter, however this is modified to account for deterioration, such that the following is used

$$Z = \frac{π}{4 {r}_{2}} ( {r}_{2}^{4} - {r}_{1}^{4} ) .$$

Where r₂ is 0.125 m and r₁ is 0, Z=0.0015398 m³. Where r₂ is 0.125 m and r₁ is 0.105 m, Z=0.0007703 m³.

Thus for a new pole (20 yr life)

φM=0.9×1×1×0.85×0.85×1×80×0.0015398=79.8 kNm

For a pole that is deteriorated, such that r₁=0.105 m,

φM=0.9×1×1×0.85×0.85×1×80×0.0007703=40.07 kNm.

Thus for a new pole the maximum horizontal load P is 79.8/10=7.98 kN, and for the degraded pole P=4.007 kNm. The maximum allowable deflection of a deteriorated pole y is

$$\frac{6.194841 \times {10}^{3}}{3 \times 18500 \times 1.49 \times {10}^{- 5}} = 0.7498 m .$$

Corresponding data (with the same degradation as above) for a 50 yr design pole is a bending moment capacity of 67.828 kNm as new, and 34.0584 kNm in the degraded case, resulting in a P=6.7828 kN (new) and P=3.40584 kN (degraded).

The deflection created by the maximum lateral force P in the 20 yr pole is 0.7498 m and for the 50 yr pole is 0.6374 m.

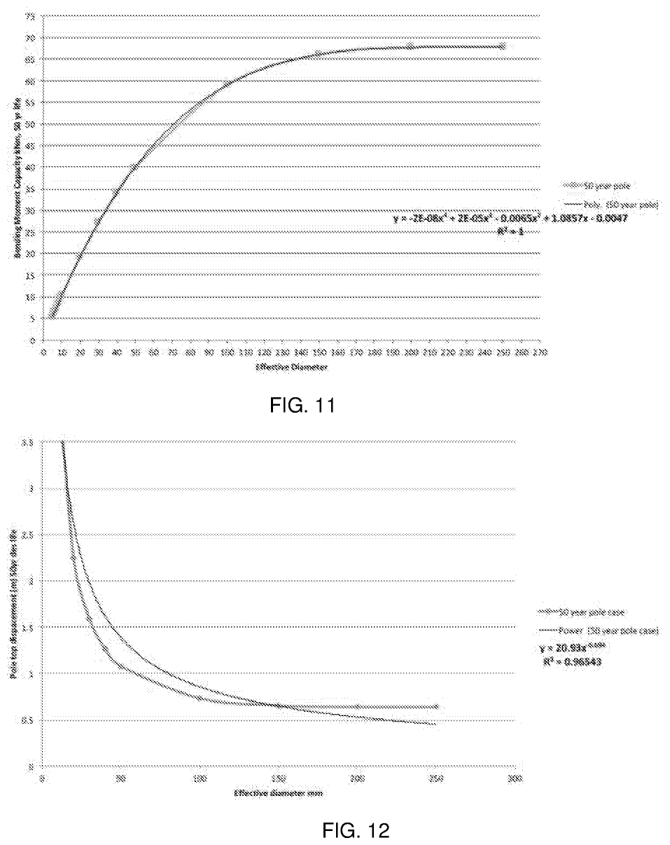

The displacement induced by the maximum lateral force P (for a new pole) against notional pole cylindrical thickness (effective diameter) can be plotted and can be fitted with an approximating power function. For example y=20.93 x^{-0.694}, where x is the effective diameter (mm) and y is the pole top displacement (m) for a 50 yr pole life. A plot of 50 year bending moment capacity versus effective diameter of a wooden pole is given in the example in FIG. 11, together with an approximating polynomial function. A plot of effective diameter versus pole top displacement is given as an example in FIG. 12.

The data for these plots is below:

POLE DESIGN CODE OPERATES TO PLACE A LIMIT ON THE ALLOWABLE DEFLECTION AT THE TOP OF THE POLE

| | | | Effective | | Bending | | Allowable | Bending | | Allowable |
|---|---|---|---|---|---|---|---|---|---|---|
| | | | Internal Dia | | Moment | Force | displacement | Moment | Force | dosplacement |
| | Outside Dia | | 0 × new pole | Remaining | capacity | (pole top) | of top of pole | capacity | (pole top) | of top of pole |
| | assume does | | increasing due | thickness | 20 yr | 20 yr | 20 yr | 50 yr | 50 yr | 50 yr |
| Strength | not change | Length | to rot, termites | (diameter) | des life | des life | des life | des life | des life | des life |
| Class | m | m | m | mm | kNm | kN | m | kNm | kN | m |
| 52 | 0.25 | 10 | 0.000 | 250 | 79.8 | 7.98 | 0.750 | 67.83 | 6.78 | 0.638 |
| 52 | 0.25 | 10 | 0.050 | 200 | 79.7 | 7.97 | 0.750 | 67.75 | 6.77 | 0.638 |
| 52 | 0.25 | 10 | 0.100 | 150 | 77.75 | 7.77 | 0.750 | 66.09 | 6.60 | 0.638 |
| 52 | 0.25 | 10 | 0.150 | 100 | 69.46 | 6.95 | 0.750 | 59.04 | 5.90 | 0.638 |
| 52 | 0.25 | 10 | 0.200 | 50 | 47.11 | 4.71 | 0.750 | 48.04 | 4.00 | 0.638 |
| 52 | 0.25 | 10 | 0.210 | 40 | 40.07 | 4.01 | 0.750 | 34.06 | 3.41 | 0.638 |
| 52 | 0.25 | 10 | 0.220 | 30 | 31.94 | 3.19 | 0.750 | 27.15 | 2.71 | 0.638 |
| 52 | 0.25 | 10 | 0.230 | 20 | 22.63 | 2.26 | 0.750 | 19.24 | 1.92 | 0.638 |
| 52 | 0.25 | 10 | 0.240 | 10 | 12.02 | 1.2 | 0.750 | 10.22 | 1.02 | 0.638 |
| 52 | 0.25 | 10 | 0.241 | 9 | 10.89 | 1.09 | 0.750 | 9.2 [symbol] | 0.93 | 0.638 |
| 52 | 0.25 | 10 | 0.242 | 8 | 9.73 | 0.97 | 0.750 | 8.27 | 0.82 | 0.638 |
| 52 | 0.25 | 10 | 0.243 | 7 | 8.57 | 0.86 | 0.750 | 7.28 | 0.73 | 0.638 |
| 52 | 0.25 | 10 | 0.244 | 6 | 7.39 | 0.74 | 0.750 | 6.28 | 0.63 | 0.638 |
| 52 | 0.25 | 10 | 0.245 | 5 | 6.19 | 0.62 | 0.750 | 5.25 | 0.53 | 0.638 |

CONSIDER THE DESIGN FORCE (WIND LOAD) OF A NEW POLE AND POLE DISPLACEMENT AS POLE AGES

| | | | Effective | | Bending | | | Bending | | |
|---|---|---|---|---|---|---|---|---|---|---|
| | | | Internal Dia | | Moment | Force | displacement | Moment | Force | displacement |
| | Outside Dia | | 0 × new pole | Remaining | capacity | (pole top) | of top of pole | capacity | (pole top) | of top of pole |
| | assume does | | increasing due | thickness | 20 yr | 20 yr | 20 yr | 50 yr | 50 yr | 50 yr |
| Strength | not change | Length | to rot, termites | (diameter) | des life | des life | des life | des life | des life | des life |
| Class | m | m | m | mm | kNm | kN | m | kNm | kN | m |
| 52 | 0.25 | 10 | 0.000 | 250 | 79.8 | 7.98 | 0.750 | 67.83 | 6.78 | 0.638 |
| 52 | 0.25 | 10 | 0.050 | 200 | 79.8 | 7.98 | 0.751 | 67.83 | 6.78 | 0.638 |
| 52 | 0.25 | 10 | 0.100 | 150 | 79.8 | 7.98 | 0.770 | 67.83 | 6.78 | 0. [symbol] |
| 52 | 0.25 | 10 | 0.150 | 100 | 79.8 | 7.98 | 0.862 | 67.83 | 6.78 | 0.733 |
| 52 | 0.25 | 10 | 0.200 | 50 | 79.8 | 7.98 | 1.270 | 67.83 | 6.78 | 1.080 |
| 52 | 0.25 | 10 | 0.210 | 40 | 79.8 | 7.98 | 1.493 | 67.83 | 6.78 | 1.269 |
| 52 | 0.25 | 10 | 0.220 | 30 | 79.8 | 7.98 | 1.873 | 67.83 | 6.78 | 1.592 |
| 52 | 0.25 | 10 | 0.230 | 20 | 79.8 | 7.98 | 2.644 | 67.83 | 6.78 | 2.247 |
| 52 | 0.25 | 10 | 0.240 | 10 | 79.8 | 7.98 | 4.977 | 67.83 | 6.78 | 4.230 |
| 52 | 0.25 | 10 | 0.241 | 9 | 79.8 | 7.98 | 5.497 | 67.83 | 6.78 | 4.672 |
| 52 | 0.25 | 10 | 0.242 | 8 | 79.8 | 7.98 | 6.147 | 67.83 | 6.78 | 5.225 |
| 52 | 0.25 | 10 | 0.243 | 7 | 79.8 | 7.98 | 6.983 | 67.83 | 6.78 | 5.936 |
| 52 | 0.25 | 10 | 0.244 | 6 | 79.8 | 7.98 | 8.098 | 67.83 | 6.78 | 6.883 |
| 52 | 0.25 | 10 | 0.245 | 5 | 79.8 | 7.98 | 9. [symbol] | 67.83 | 6.78 | 8.210 |

[symbol]

indicates data missing or illegible when filed

A displacement threshold can be implemented where the displacement is monitored and when it is greater than a selected amount, for example when the displacement is greater than 1000 mm, this can be used to trigger an alert that the pole is suspected to have deteriorated to less than 58% of its original strength, with an effective internal diameter of 80% that is not able to support load, leaving only the outer 20% to support load, or that its movement is unusual given the lateral wind load, given the recorded weather conditions.

Through the tracking of the pole's residual strength over time, the hidden defect poles can be identified and removed from service; the poles nearing the limit of their residual strength to their load case can also be identified and removed from service; and the poles which have a longer than expected life, through a combination of higher than average strength at the start of their duty, and benign environmental conditions, can stay in service for periods considerably longer than current industry practice.

The rate of reduction of strength over time is also tracked and used to predict the pole's future performance and when the pole's residual strength will no longer be sufficient to withstand the load case.

Sudden reductions in the permanent, changing lateral displacement and lateral angle of the pole during periods of low wind that are not attributed to a sudden increase in current load or a sudden increase in ambient temperature, or both, may be attributed to a weakness or failure of the system of components that transfer the lateral force from the conductor to the pole, including: the state of the tie wires connecting the conductor to the insulator; the insulator that fastens the conductor to the cross arm and also acts as the insulator to prevent a short circuit to ground; the cross arm that connects the insulator to the power pole; the cross arm connectors and the insulator connectors that carry the lateral force.

Sudden increases in the permanent, changing lateral displacement and lateral angle of the pole during periods of low wind that are not attributed to a sudden decrease in current load or a sudden decrease in ambient temperature, or both, may be attributed to a weakness or failure of the pole or the pole strengthening element at the base of the pole.

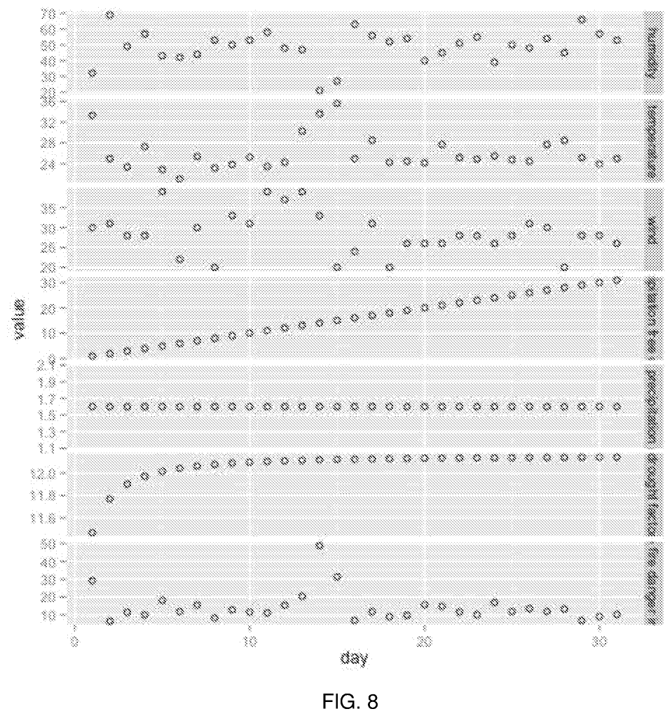

By way of another example FIGS. 7 and 8 illustrate a state of the powerline arcing or short circuiting across the insulator(s) in more detail. FIG. 7 shows a temperature map of an area in which an asset, such as power line 10 is located. This temperature data, as well as other meteorological data can be obtained from the meteorological service. Alternatively localised temperature measurements can be taken by infrared sensors in devices 30 on some or all of the power poles 12, 14, 18, 20 of the power line 10. Poles may be clustered by proximity and compared to meteorological service date, depending on the scale of the area that the data represents. The localised temperature experienced by each pole according to the measured data is compared to the area's temperature, humidity and precipitation data. A localised high temperature reading (relative to the area's air temperature) can indicate arcing or short circuiting across the insulator(s). This abnormal temperature comparison can be used to raise an alert.

Additionally light levels received by a sensor relative to meteorological conditions can indicate a built up of dust over a long dry period. Dust and light precipitation are potential instigators of arcing or short circuiting across the insulator(s). FIG. 8 shows example measurements of humidity, temperature, wind, precipitation free days, precipitation levels, a drought factor and an arcing or short circuiting across the insulator(s)/fire risk factor.

In an embodiment a pole fire danger index (PFDI) is determined from a drought factor. In an embodiment the PFDI is determined from e to the power of a linearly scaled natural logarithm of the drought factor.

In an embodiment the PFDI is determined from the temperature. In an embodiment the PFDI is determined by the temperature having a scaled contribution to the contribution of the drought factor. In an embodiment the PFDI is determined by the humidity having a negatively scaled contribution to the contribution of the drought factor. In an embodiment the PFDI is determined by the wind velocity having a scaled contribution to the contribution of the drought factor.

In an embodiment the drought factor is determined from a linearly scaled Keetch-Byram Drought Index. In an embodiment the drought factor is determined from the number of days since the last rain event and the amount of precipitation in the last rain event.

In an embodiment the PFDI equals:

PFDI=2×e^{(0.987×ln(DF)-0.45-0.0345H+0.0338T+0.0234V)}

Where

$$DF = \frac{0.191 \times ( K + 104 ) \times {( N + 1 )}^{1.5}}{P - 1 + 3.52 \times {( N + 1 )}^{1.5}} ,$$

T=air temperature (in ° C.), H=relative humidity (as a %), V=average 10-m open wind velocity (in km/hr), K=Keetch-Byram Drought Index, N=number of days since the last rain event and P=precipitation in the last rain event (in mm). The Keetch-Byram Drought Index represents the amount of rainfall required to saturate the top 200 mm of topsoil (Keetch, John J; Byram, George. 1968. “A drought index for forest fire control.” Res. Paper SE-38. Asheville, N.C.: U.S. Department of Agriculture, Forest Service, Southeastern Forest Experiment Station. 32 pp.).

In an embodiment the comparison measurement comprises a relationship factor between the precipitation levels, humidity, temperature and the light levels received by a sensor. In an embodiment the received meteorological data and the sensor data are regarded as substantially different from the generated comparison measurement when meteorological conditions indicate high light levels, but a measurement of light sensor indicates low light level, and this may be used to indicate a build-up of dust on the asset. In an embodiment the received meteorological data and the sensor data is regarded as substantially different from the generated comparison measurement when measured light level of the asset is low and the precipitation, humidity and temperature indicate that the asset has a built up of dust over a long dry period and the meteorological data suggests there is a chance of light precipitation.

In an embodiment when the PFDI is above a threshold, light level from the sensor is below a threshold, and there is a prediction of light amounts of precipitation, an alert indicating an increased likelihood that arcing or short circuiting across the insulator(s) will occur is generated.

In an embodiment the alert triggers maintenance of the asset or an alarm indicating that the asset is a state that requires immediate attention.

A significant issue for conductor failure is the impact of trees in the environment near the lines, either from trees falling over on the lines, or branches falling over on the lines, or branches coming into near proximity or contact with the lines during periods of high winds and causing short circuits, arcing and molten metal release from the conductors. Motion sensors mounted on the trees near power lines, called Hazard Trees, and on the suspect branches of the Hazard Trees, can then monitor the motion of these branches multiple times an hour. Alarms can be created when the branch moves too close to the power line during periods of high winds, or due to natural growth of the tree branch. Over time, trends of the natural movement of the Hazard Tree are created under a range of environmental conditions, and an early warning of failure can then be created if the Hazard Tree moves away from its trend line over time.

The Hazard Tree Sensor communicates data to the nearest power pole sensor 30 via a radio signal and the analysis of the data forms part of the visual reporting of alarms to the utility company.

Visual and infrared cameras may be mounted in the pole sensor 30 to take photos of the power lines in both directions and these photos are communicated to the data centre 40 via the network 50. Through pattern recognition of these photos over time, identification of new hazard trees or branches can be identified.

Visual and infrared cameras mounted on the pole sensor take photos of the cross arm, insulators and conductor tie cables and associated connectors. These photos are communicated with the other data to a data centre 40 for analysis. Over time, through pattern recognition, differences in these photos are identified and used to identify alarms and faults in conjunction with visual inspection by a skilled technician.

One of sensors may be configured to measure conductor tension. Data from this sensor, in conjunction with the wind strength, and temperature, can be used to optimise the current load through the conductors to increase the load capacity of the power line as a whole. For example, in periods of low temperature and light winds, the heat loss from the conductors is high, and the current load can be increased, relative to conditions of very high ambient temperature and high winds.

Due to the variability of environmental conditions and individual characteristics of the poles it is advantageous that the present invention provides information that can lead to a significant increase in service life for the subset of poles that are significantly stronger and installed in benign environments.

An aspect of the present invention can monitor trees of interest creating better information of the tree's dynamic movement under windy and still conditions, and under snow load or ice load, or a combination of these factors, and also creating information about the tree's medium term growth and long term stability, so as to in turn determine its possible impact on an adjacent asset.

Modifications may be made to the present invention within the context of that described and shown in the drawings. Such modifications are intended to form part of the invention described in this specification.

1. A method of prediction of a state of an asset, said method comprising:
receiving meteorological data related to a locality of the asset over time;
receiving sensor data from one or more sensors measuring a condition experienced by the asset over time,
generating a comparison measurement between the meteorological data and the sensor data which indicates meteorological environmental impacts on the asset over time,
wherein the generation of the comparison accounts for non-meteorological changes in conditions experienced by the asset over time;
identifying when there is a substantial change to the comparison measurement over time;
creating an output based on the identified substantial change as a prediction of a particular state of the asset.

2. A method according to claim 1, wherein the asset is a powerline pole and the non-meteorological changes in conditions experienced by the asset over time comprise inherent conditions of the asset that change over time.

3. A method according to claim 2, wherein the received meteorological data is of an area in which the asset is located and the received meteorological data is acquired from a source external to the asset.

4. A method according to claim 2 or 3, wherein the meteorological data comprises wind data for the area in which the asset is located, the sensor data comprises movement data of the asset and current loading through a conductor of the asset recorded over time.

5. A method according to any one of claims 1 to 4, wherein accounting for non-meteorological changes over time comprises determining the stationary position of a pole top over time from the sensor data and taking into account the change in the stationary pole top position over time.

6. A method according to any one of claims 1 to 5, wherein accounting for non-meteorological changes over time comprises determining the stationary angle of the pole relative to horizontal over time from the sensor data and taking into account the change in the stationary angle of the pole top over time.

7. A method according to any one of claims 1 to 6, wherein the sensor data comprises powerline tension.

8. A method according to any one of claims 1 to 7, wherein at least one of the sensors measures a dynamic condition experienced by the asset.

9. A method according to claim 8, wherein at least one of the sensors is used to determine a non-dynamic distortion or movement of a part of the asset over time and the method further comprises determining the non-dynamic distortion or movement of a part of the asset over time.

10. A method according to any one of claims 1 to 9, wherein the generated comparison measurement accounts for one or more of the following:
temperature related movement of the asset that is unrelated to ambient air temperature;
conductor loading on the pole;
permanent changes in the position of the conductor carrying part of the pole;
and/or
changes in static loading over time.

11. A method according to any one of claims 1 to 10, wherein the method further comprises determining a static lateral force exerted on the power pole, based on its stationary position, stationary angle, conductor current load, air temperature; determining a dynamic lateral force exerted on the power pole; and correcting the determined dynamic lateral force to account for the determined static lateral force.

12. A method according to any one of claims 1 to 11, wherein the method further comprises separating the load and temperature components of lateral pole movement during periods of low lateral wind load; analysing movement of the pole with the effects of temperature and current load having been corrected during periods of high lateral wind load.

13. A method according to claim 12, wherein the method further comprises calculating the power pole's residual strength during each period of low lateral wind load and each period of high lateral wind load.

14. A method according to claim 13, wherein the method further comprises comparing the residual strength to the power pole's load case to determine whether the power pole's residual strength is sufficient to withstand the load case, using a model of the pole that has an external diameter of load bearing material, and an internal diameter of non-load bearing material.

15. A method according to any one of claim 13 or 14, wherein the method further comprises tracking the rate of reduction of residual strength over time to predict the pole's future performance and when the pole's residual strength will no longer be sufficient to withstand the load case.

16. A method according to any one of claims 1 to 15, wherein determining the state of the asset comprises determining whether there is a sudden reduction in the permanent, changing lateral displacement and lateral angle of the pole during periods of low wind that is not attributed to a sudden increase in current load or a sudden increase in ambient temperature, or both, and in that case the state of the asset is that there is a weakness that may be attributed to a system of components that transfer the lateral force from the conductor to the pole.

17. A method according to any one of claims 1 to 16, wherein determining the state of the asset comprises determining whether there is a sudden increase in the permanent, changing lateral displacement and lateral angle of the pole during periods of low wind that is not attributed to a sudden decrease in current load or a sudden decrease in ambient temperature, or both, and in that case the state of the asset is that there is a weakness that may be attributed to the pole or a pole strengthening element at the base of the pole.

18. A method according to any one of claims 1 to 17, wherein one of the sensors comprises a motion sensor mounted on the trees near power lines; and the state of the asset is regarded as being susceptible to impact by a tree when the branch moves too close to the power line during periods of high winds, or due to natural growth of the tree branch.

19. A method according to any one of claims 1 to 18, wherein one of the sensors comprises a camera mounted so as to take photos of the power line, such that the photo can be analysed with pattern recognition over time so as to identify new hazard trees or branches or faults with the cross arm, insulators and conductor tie cables and associated connectors.

20. A method according to any one of claims 1 to 19, wherein the meteorological data comprises precipitation levels, and humidity for the area in which the asset is located.

21. A method according to any one of claims 1 to 20, wherein the sensor data comprises temperature and ambient light levels received by a sensor at the asset.

22. A method according to any one of claims 1 to 19, wherein the meteorological data comprises precipitation levels, and humidity for the area in which the asset is located; the sensor data comprises temperature and ambient light levels received by a sensor at the asset; wherein the comparison measurement comprises a characteristic of a relationship between the precipitation levels, humidity, temperature and the light levels received by a sensor.

23. A method according to claim 22, wherein the received meteorological data and the sensor data are regarded as substantially different from the generated comparison measurement when meteorological conditions indicate high light levels, but a measurement of light sensor indicates low light level, and this is used to indicate a build-up of dust on the asset.

24. A method according to any one of claims 22 to 23, wherein the received meteorological data and the sensor data are regarded as substantially different from the generated comparison measurement when measured light level of the asset is low and the precipitation, humidity and temperature indicate that the asset has a build up of dust over a long dry period and the meteorological data suggests there is a chance of light precipitation occurring.

25. A method according to any one of claims 1 to 24, wherein the metrological data comprise one or more of: air temperature, wind speed, wind direction, quantitative precipitation, atmospheric pressure, humidity.

26. A method according to any one of claims 1 to 25, wherein the sensor data comprise one or more of: smoke, methane, and carbon monoxide.

27. A method according to any one of claims 1 to 15, wherein the measured data comprises one or more of: non-dynamic movements of the asset, settled dust on the asset, conductor tension, temperature of the pole top equipment, and current load in the conductors.

28. A method according to any one of claims 1 to 27, wherein the meteorological data is used to determine a pole fire danger index.

29. A method according to any one of claim 11, 16, or 17, wherein the movement data and angle data is used to predict current state of the asset when movement exceeds a threshold.

30. A method according to claim 29, wherein the movement threshold is determined according to a section modulus which has been modified to a notional hollow cylinder where the hollow increases in diameter with increased deterioration of the asset.

31. A method of prediction of a state of a power pole, said method comprising:
receiving sensor data from one or more sensors measuring a state of the power pole over time;
determining from the received sensor data a first data group which is reflective of movement of the power pole over time during periods of no or low wind lateral to a power line direction;
determining from the received sensor data a second data group which is reflective of movement of the power pole over time during periods of high wind lateral to the power line direction;
comparing the first data group to the second data group over time;
identifying when the comparison indicates a state of the asset has changed;
creating an alert when the state is indicated as having changed, as a prediction of a particular state of the asset.

32. A method according to claim 31, wherein the sensor data is movement of the asset over time during periods of no or low wind lateral to the power line direction, and during periods of high wind lateral to the power line direction, and the state is a current state of the structure of the asset.

33. A method according to claim 32, wherein a movement threshold is determined in periods of low wind lateral to the power line direction, after adjustment for the effect of temperature and conductor current load, and compared to prior records of movement in the same pole under similar conditions.

34. A method of prediction of a state of an asset, said method comprising:
receiving sensor data from one or more sensors measuring a state of the asset over time;
generating a comparison measure of the sensor data over time;
identifying when the comparison indicates a state of the asset has changed;
creating an alert when the state is indicated as having changed, as a prediction of a particular state of the asset, wherein the sensor data is dust levels on the asset or light levels that indicate dust levels on the asset, and the state is being at risk of arcing or short circuiting across insulator(s) of the asset.

35. A method according to claim 34, wherein the sensor data is temperature, humidity, wind speed, and time since the last precipitation, and amount of the last precipitation, and the comparison measurement is an indicator of arcing or short circuit across an insulator of a powerline.

36. A method of prediction of a state of a powerline, said method comprising:
receiving meteorological data related to an area in which the powerline is located over time;
receiving sensor data from one or more sensors measuring a condition experienced by the powerline over time;
generating a comparison measurement between the meteorological data and the sensor data which indicates meteorological environmental impacts on the asset over time,
wherein the generation of the comparison is configured to identify arcing or short circuiting;
identifying when there is a substantial change to the comparison measurement over time;
creating an output based on the identified substantial change as a prediction that the powerline may be at risk of arcing or short circuiting.

37. A system for prediction of a state of an asset, said system comprising:
a receiver of meteorological data related to locality of the asset over time;
a receiver of sensor data from one or more sensors measuring a state of the asset over time;
a comparator for generating a comparison measurement between the meteorological data and the sensor data which indicates meteorological environmental impacts on the asset over time, wherein the generation of the comparison accounts for non-meteorological changes in conditions experienced by the asset over time;
a detector for identifying when there is a substantial change to the comparison measurement over time;
an output generator for creating an output based on the identified substantial change as a prediction of a particular state of the asset.

38. A system for prediction of a state of an asset, said system comprising:
means for receiving meteorological data related to locality of the asset over time;
means for receiving sensor data from one or more sensors measuring a state of the asset over time;
means for generating a comparison measurement between the meteorological data and the sensor data which indicates meteorological environmental impacts on the asset over time, wherein the generation of the comparison accounts for non-meteorological changes in conditions experienced by the asset over time;
means for identifying when there is a substantial change to the comparison measurement over time;
means for creating an output based on the identified substantial change as a prediction of a particular state of the asset.

39. A computer program embodied in a non-volatile computer readable medium for prediction of a state of an asset, said computer program comprising instructions for controlling a processor to:
receive meteorological data related to locality of the asset over time;
receive sensor data from one or more sensors measuring a state of the asset over time;
generate a comparison measurement between the meteorological data and the sensor data which indicates meteorological environmental impacts on the asset over time,
wherein the generation of the comparison accounts for non-meteorological changes in conditions experienced by the asset over time;
identify when there is a substantial change to the comparison measurement over time;
create an output based on the identified substantial change as a prediction of a particular state of the asset.

40. A system for prediction of a state of a power pole, said system comprising:
a receiver of sensor data from one or more sensors measuring a state of the power pole over time;
a processor for determining from the received sensor data a first data group which is reflective of movement of the power pole over time during periods of no or low wind lateral to a power line direction;
a processor for determining from the received sensor data a second data group which is reflective of movement of the power pole over time during periods of high wind lateral to the power line direction;
a comparator for comparing the first data group to the second data group over time;
a detector for identifying when the comparison indicates a state of the asset has changed;
an output generator for creating an alert when the state is indicated as having changed, as a prediction of a particular state of the asset.

41. A system for prediction of a state of a power pole, said system comprising:
means for receiving sensor data from one or more sensors measuring a state of the power pole over time;
means for determining from the received sensor data a first data group which is reflective of movement of the power pole over time during periods of no or low wind lateral to a power line direction;
means for determining from the received sensor data a second data group which is reflective of movement of the power pole over time during periods of high wind lateral to the power line direction;
means for comparing the first data group to the second data group over time;
means for identifying when the comparison indicates a state of the asset has changed;
means for creating an alert when the state is indicated as having changed, as a prediction of a particular state of the asset.

42. A computer program embodied in a non-volatile computer readable medium for prediction of a state of a power pole, said computer program comprising instructions for controlling a processor to:
receive sensor data from one or more sensors measuring a state of the power pole over time;
determine from the received sensor data a first data group which is reflective of movement of the power pole over time during periods of no or low wind lateral to a power line direction;
determine from the received sensor data a second data group which is reflective of movement of the power pole over time during periods of high wind lateral to the power line direction;
compare the first data group to the second data group over time;
identify when the comparison indicates a state of the asset has changed;
create an alert when the state is indicated as having changed, as a prediction of a particular state of the asset.

43. A system for prediction of a state of a powerline, said system comprising:
a receiver of meteorological data related to an area in which the powerline is located over time;
a receiver of sensor data from one or more sensors measuring a condition experienced by the powerline over time;
a comparator for generating a comparison measurement between the meteorological data and the sensor data which indicates meteorological environmental impacts on the asset over time, wherein the generation of the comparison is configured to identify arcing or short circuiting;
a detector for identifying when there is a substantial change to the comparison measurement over time;
an output generator for creating an output based on the identified substantial change as a prediction that the powerline may be at risk of arcing or short circuiting.

44. A system for prediction of a state of a powerline, said system comprising:
means for receiving meteorological data related to an area in which the powerline is located over time;
means for receiving sensor data from one or more sensors measuring a condition experienced by the powerline over time;
means for generating a comparison measurement between the meteorological data and the sensor data which indicates meteorological environmental impacts on the asset over time, wherein the generation of the comparison is configured to identify arcing or short circuiting;
means for identifying when there is a substantial change to the comparison measurement over time;
means for creating an output based on the identified substantial change as a prediction that the powerline may be at risk of arcing or short circuiting.

45. A computer program embodied in a non-volatile computer readable medium for prediction of a state of a powerline, said computer program comprising instructions for controlling a processor to:
receive meteorological data related to an area in which the powerline is located over time;
receive sensor data from one or more sensors measuring a condition experienced by the powerline over time;
generate a comparison measurement between the meteorological data and the sensor data which indicates meteorological environmental impacts on the asset over time,
wherein the generation of the comparison is configured to identify arcing or short circuiting;
identify when there is a substantial change to the comparison measurement over time;
create an output based on the identified substantial change as a prediction that the powerline may be at risk of arcing or short circuiting.

46. A system for prediction of a state of an asset, said method comprising:
a receiver of sensor data from one or more sensors measuring a state of the asset over time;
a processor for generating a comparison measure of the sensor data over time;
a processor for identifying when the comparison indicates a state of the asset has changed;
a detector creating an alert when the state is indicated as having changed, as a prediction of a particular state of the asset, wherein the sensor data is dust levels on the asset or light levels that indicate dust levels on the asset, and the state is being at risk of arcing or short circuiting across insulator(s) of the asset.

47. A system for prediction of a state of an asset, said method comprising:
means for receiving sensor data from one or more sensors measuring a state of the asset over time;
means for generating a comparison measure of the sensor data over time;
means for identifying when the comparison indicates a state of the asset has changed;
means for creating an alert when the state is indicated as having changed, as a prediction of a particular state of the asset, wherein the sensor data is dust levels on the asset or light levels that indicate dust levels on the asset, and the state is being at risk of arcing or short circuiting across insulator(s) of the asset.

48. A computer program embodied in a non-volatile computer readable medium for, predicting a state of an asset, said computer program comprising instructions for controlling a processor to:
receive sensor data from one or more sensors measuring a state of the asset over time;
generate a comparison measure of the sensor data over time;
identify when the comparison indicates a state of the asset has changed;
create an alert when the state is indicated as having changed, as a prediction of a particular state of the asset, wherein the sensor data is dust levels on the asset or light levels that indicate dust levels on the asset, and the state is being at risk of arcing or short circuiting across insulator(s) of the asset.
